(19) United States
(12) Patent Application Publication
(10) Pub. No.: US 2026/0280161 A1
(43) Pub. Date: Sep. 17, 2026

(54) CLIP-TYPE CONNECTOR AND DEVICE

(71) Applicant: SMK Corporation, Tokyo (JP)

(72) Inventor: Yuki KOYAMA, Cupertino, CA (US)

(21) Appl. No.: 19/679,743

(22) Filed: May 17, 2026

Related U.S. Application Data
(63) Continuation of application No. PCT/JP2024/010027, filed on Mar. 14, 2024.
(60) Provisional application No. 63/604,144, filed on Nov. 29, 2023.

(51) Int. Cl. H01R 11/22; H01R 4/18; H01R 4/48; H01R 43/027

(52) U.S. Cl. CPC H01R 11/22; H01R 4/184; H01R 4/4821; H01R 43/027

(57) ABSTRACT

A clip-type connector includes: a base portion having a main surface; a wall portion extending upright from the base portion; a first elastic portion and a second elastic portion, the first elastic portion and the second elastic portion being located on a side of the wall portion opposite to the base portion and separated from each other in a direction along the main surface; a coupling portion that couples the first elastic portion and the second elastic portion, the coupling portion facing the main surface and being located on a side of the first elastic portion and the second elastic portion opposite to the wall portion; and a first extension portion between the first elastic portion and the second elastic portion, the first extension portion extending from the coupling portion toward the wall portion.

The contents of the following patent application(s) are incorporated herein by reference:
NO. 63/604144 filed in U.S. on Nov. 29, 2023
NO. PCT/JP2024/010027 filed in WO on Mar. 14, 2024.

### FIELD

The present invention relates to a clip-type connector and a device.

### BACKGROUND

Patent Literature 1 discloses a female terminal assembly that receives a male terminal between a pair of protruding portions provided at a smaller gap whose width is shorter than the thickness of the male terminal. Patent Literatures 2 to 16 disclose technologies about clip-type or pinch-type connectors.

### CITATION LIST

### Patent Literature

Patent Literature 1: Specification of Japanese Patent No. 5156864
Patent Literature 2: Examined Japanese Utility Model Publication No. H04-009752
Patent Literature 3: Examined Japanese Utility Model Publication No. H04-009753
Patent Literature 4: Japanese Utility Model Application Laid-Open No. S56-076274
Patent Literature 5: Examined Japanese Patent Publication No. H06-028177
Patent Literature 6: Specification of Japanese Patent No. 3546479
Patent Literature 7: Specification of Japanese Patent No. 5158551
Patent Literature 8: Specification of Japanese Patent No. 6008783
Patent Literature 9: Specification of Japanese Patent No. 6754031
Patent Literature 10: Specification of Japanese Patent No. 7004542
Patent Literature 11: Japanese Patent Application Laid-Open No. 2007-234373
Patent Literature 12: Japanese Patent Application Laid-Open No. 2018-156734
Patent Literature 13: Japanese Patent Application Laid-Open No. 2022-122739
Patent Literature 14: Japanese Patent Application Laid-Open No. 2023-047375
Patent Literature 15: Japanese Patent Application Laid-Open No. H09-223527
Patent Literature 16: Specification of Japanese Utility Model Registration No. 3024960

### BRIEF DESCRIPTION OF THE DRAWINGS

FIG. 1 is a perspective view of a device 5 including a clip-type connector 100 according to a first embodiment.

FIG. 2 is a perspective view of the clip-type connector 100.

FIG. 3 is a top view of the clip-type connector 100.

FIG. 4 is a cross-sectional view of the clip-type connector 100.

FIG. 5 is a perspective view illustrating the situation where a jig 150 is applied to the clip-type connector 100.

FIG. 6 illustrates the cross section of the clip-type connector 100 and the jig 150 in the situation of FIG. 5.

FIG. 7 is a cross-sectional view illustrating the situation where an electrical contact 42 is lifted in a positive y-axis direction by the jig 150.

FIG. 8 is a cross-sectional view illustrating a state in which the clip-type connector 100 is mounted on a mounting target member 140 while the electrical contact 42 is lifted by the jig 150.

FIG. 9 is a cross-sectional view illustrating a state in which the jig 150 has been removed from the clip-type connector 100 after the clip-type connector 100 was mounted on the mounting target member 140.

FIG. 10 is a cross-sectional view of a clip-type connector 200 as a modification of the clip-type connector 100.

FIG. 11 is a perspective view illustrating a clip-type connector 300 according to a second embodiment.

FIG. 12 is a top view of the clip-type connector 300.

FIG. 13 is a cross-sectional view of the clip-type connector 300.

### DESCRIPTION OF EMBODIMENTS

The present invention will be described hereinafter through embodiments of the invention, but the following embodiments do not limit the scope of the invention as claimed. Furthermore, all combinations of features described in the embodiments are not necessarily essential for the solution of the invention.

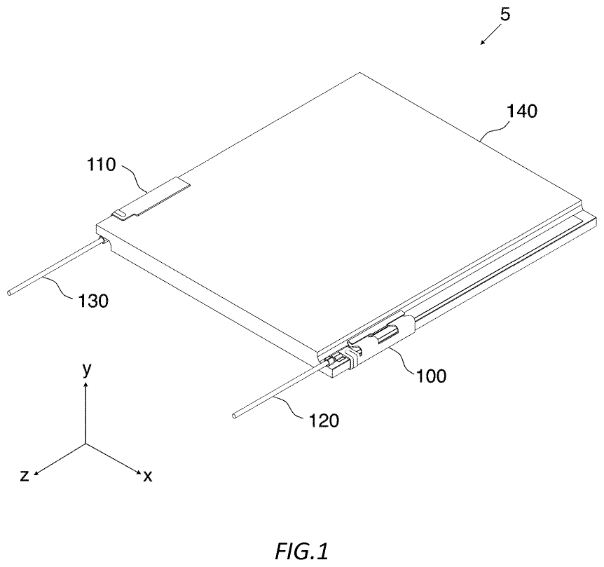

FIG. 1 is a perspective view of a device 5 including a clip-type connector 100 according to a first embodiment. The device 5 includes a clip-type connector 110, a mounting target member 140, an electrical wire 120, and an electrical wire 130. The clip-type connector 100 and the clip-type connector 110 pinch the mounting target member 140 to be mounted on the mounting target member 140. The mounting target member 140 may be, but is not limited to, a plate-shaped member such as a solar cell panel, for example.

The clip-type connector 100 is fixed to the clip-type connector 100 such that the electrical wire 120 and the clip-type connector 100 are electrically connected to each other. The clip-type connector 110 is fixed to the clip-type connector 110 such that the electrical wire 130 and the clip-type connector 110 are electrically connected to each other. The clip-type connector 110 has the same configuration as that of the clip-type connector 100. Therefore, a detailed description of the clip-type connector 110 will be omitted.

In the present embodiment, the configuration possessed by the device 5 or the clip-type connector 100 or the like, and a right-handed Cartesian coordinate system including an x-axis, a y-axis, and a z-axis are illustrated mainly for describing the configuration possessed by the device 5 in an easy-to-understand manner. In the present embodiment, the Cartesian coordinate system may be used to describe the configuration of the device 5, the clip-type connector 100 or the like.

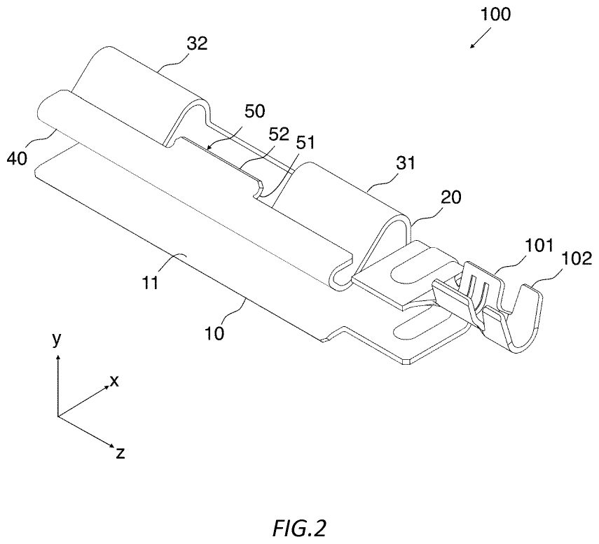

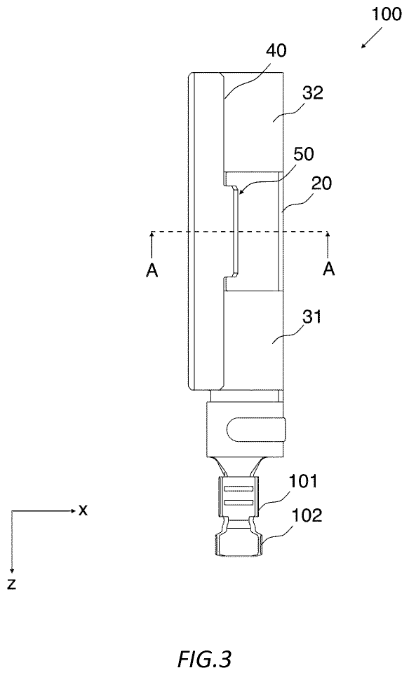

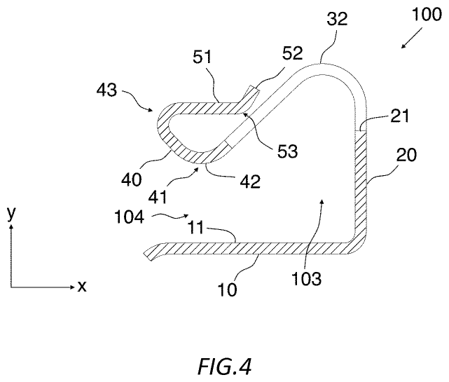

FIG. 2 is a perspective view of the clip-type connector 100. FIG. 3 is a top view of the clip-type connector 100. FIG. 4 is a cross-sectional view of the clip-type connector 100. Specifically, FIG. 4 illustrates a cross section taken along line A-A in FIG. 3.

The clip-type connector 100 is formed of a conductive member. The clip-type connector 100 is formed of, for example, a metallic member. The clip-type connector 100 is formed of, for example, one metal plate. The clip-type connector 100 includes a base portion 10, a wall portion 20, a first elastic portion 31, a second elastic portion 32, a coupling portion 40, an extension portion 50, a first crimp portion 101, and a second crimp portion 102.

In the first crimp portion 101, a conductive member of the electrical wire 120 is crimped while the conductive member of the electrical wire 120 is electrically connected to the first crimp portion 101. In the second crimp portion 102, a cover member of the conductive member of the electrical wire 120 is crimped. This configuration substantially fixes the electrical wire 120 to the clip-type connector 100.

The base portion 10 has a main surface 11. The main surface 11 extends in a direction of the z-axis.

The wall portion 20 extends upright from the base portion 10. Specifically, the wall portion 20 extends upright from the main surface 11 of the base portion 10. The wall portion 20 extends upright in a positive y-axis direction from the main surface 11 of the base portion 10.

The first elastic portion 31 and the second elastic portion 32 are located on the side of the wall portion 20 opposite to the base portion 10. The first elastic portion 31 and the second elastic portion 32 are separated from each other in the direction along the main surface 11.

The coupling portion 40 couples the first elastic portion 31 and the second elastic portion 32. The coupling portion 40 couples the first elastic portion 31 and the second elastic portion 32 in the direction of the z-axis. The coupling portion 40 faces the main surface 11 and is located on the side of the first elastic portion 31 and the second elastic portion 32 opposite to the wall portion 20. The coupling portion 40 has an electrical contact 42 at a position facing the main surface 11. The coupling portion 40 has a curved portion 41. The electrical contact 42 is a part in the vicinity of an apex of the curved portion 41. The electrical contact 42 is specifically a part in the vicinity of the apex of the curved portion 41 in the y-axis direction.

With the configuration described above, the base portion 10, the wall portion 20, the first elastic portion 31 and the second elastic portion 32, and the coupling portion 40 has a shape that forms a space 103 and a gap 104 for receiving the mounting target member 140 while defining a shape that surrounds the space 103. When a force in a positive z-axis direction is applied to the coupling portion 40, a restoring force in a negative z-axis direction is generated in the first elastic portion 31 and the second elastic portion 32. Thus, when the mounting target member 140 is inserted into a gap between the electrical contact 42 and the main surface 11, restoration of the first elastic portion 31 and the second elastic portion 32 allows the mounting target member 140 to be pinched between the electrical contact 42 and the main surface 11. As a result, the electrical contact 42 is pressed toward the mounting target member 140.

The extension portion 50 extends from the coupling portion 40 toward the wall portion 20 between the first elastic portion 31 and the second elastic portion 32 as illustrated in FIGS. 2 and 3 or other drawings, for example. The extension portion 50 has a first extension portion 51 and a second extension portion 52. The first extension portion 51 extends from the coupling portion 40 toward the wall portion 20 between the first elastic portion 31 and the second elastic portion 32 as illustrated in FIG. 4 or other drawings, for example. Specifically, as illustrated in FIG. 4 or other drawings, the first extension portion 51 extends mainly in the positive x-axis direction.

The coupling portion 40 has a curved portion 43 on the opposite side of the first elastic portion 31 and the second elastic portion 32. The curved portion 43, at least between the first elastic portion 31 and the second elastic portion 32, is curved toward the wall portion 20. The first extension portion 51 extends toward the wall portion 20 from the side of the curved portion 43 opposite to the first elastic portion 31 and the second elastic portion 32.

The coupling portion 40 has the second extension portion 52 extending in a direction away from the base portion 10 from the side of the first extension portion 51 opposite to the coupling portion 40. As illustrated in FIG. 4 or other drawings, the first extension portion 51 extends mainly in the positive x-axis direction, while the second extension portion 52 extends mainly in the positive x-axis direction and the positive y-axis direction. Thus, at least a part of the second extension portion 52 is located between the first elastic portion 31 and the second elastic portion 32 in the direction along the main surface 11.

As illustrated in FIG. 4 or other drawings, the first extension portion 51 has a jig receiver 53 that comes into contact with a jig used to mount the clip-type connector 100 on the mounting target member 140. The jig receiver 53 is a region of the first extension portion 51 in the vicinity of the second extension portion 52. The jig receiver 53 will be described later.

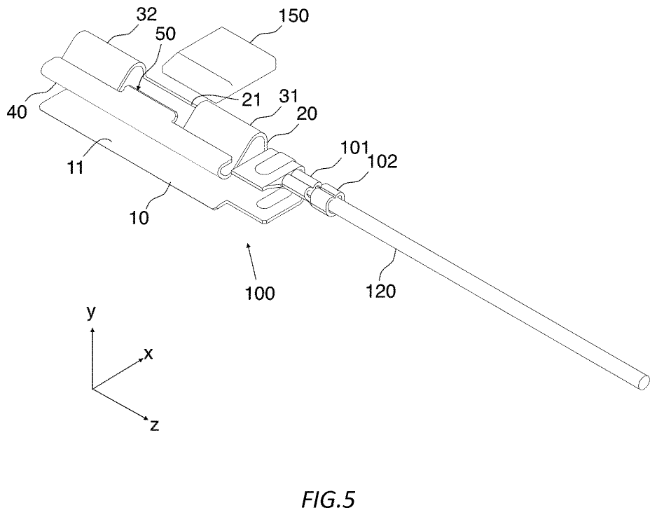

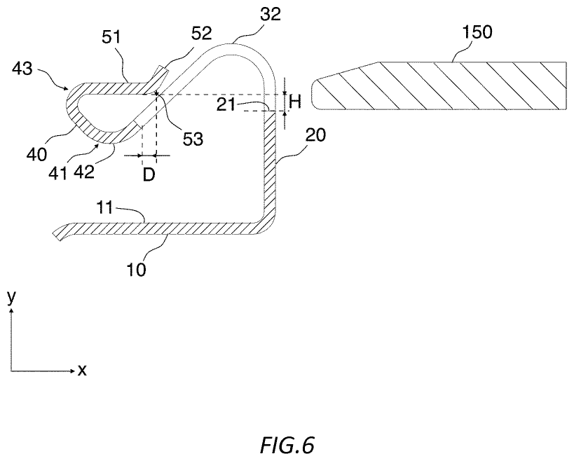

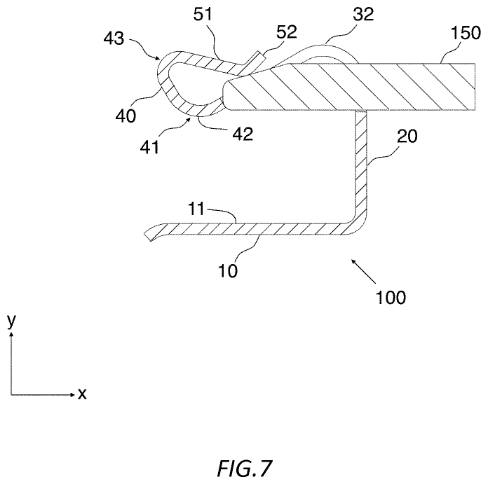

FIG. 5 is a perspective view illustrating the situation where the jig 150 is applied to the clip-type connector 100. The jig 150 is used to mount the clip-type connector 100 on the mounting target member 140. Specifically, the jig 150 is used to widen a gap between the main surface 11 and the electrical contact 42. FIG. 6 illustrates the cross section of the clip-type connector 100 and the jig 150 in the situation of FIG. 5. FIG. 7 is a cross-sectional view illustrating the situation where the electrical contact 42 is lifted in the positive y-axis direction by the jig 150. FIGS. 6 and 7 are cross-sectional views at the same position as the cross section taken along line A-A in FIG. 3.

As illustrated in FIG. 5 or other drawings, the jig 150 is inserted between the first elastic portion 31 and the second elastic portion 32. For example, the jig 150 is inserted in a direction from the wall portion 20 to the coupling portion 40. Specifically, the jig 150 can be inserted in the negative x-axis direction, as illustrated in FIG. 6 or other drawings.

As illustrated in FIGS. 5 and 6 or other drawings, between the first elastic portion 31 and the second elastic portion 32, an end portion 21 of the wall portion 20 on the side opposite to the base portion 10 is at a position lower than the first extension portion 51 relative to the base portion 10. Specifically, as illustrated in FIG. 6, the end portion 21 is at a position lower by H than the first extension portion 51 in the y-axis direction. Therefore, when the jig 150 is inserted in the direction from the wall portion 20 to the coupling portion 40 (in the negative x-axis direction), the jig 150 comes into contact with the jig receiver 53 of the second extension portion 52. When the jig 150 is inserted further toward the coupling portion 40, a force in the direction of pressing the first extension portion 51 upward in the positive y-axis direction is applied to the first extension portion 51 from the jig 150. The force causes elastic deformation of the first elastic portion 31 and the second elastic portion 32, thereby pressing the electrical contact 42 upward in the positive y-axis direction. Thus, by inserting the jig 150 along the x-axis direction, the electrical contact 42 can be lifted in the positive y-axis direction. This configuration makes it possible to widen the gap between the electrical contact 42 and the main surface 11.

As described above, the second extension portion 52 extends in the direction toward the wall portion 20 and in the direction away from the base portion 10. As a result, even when the position at which the jig 150 is inserted is slightly shifted in the positive y-axis direction, the jig 150 can be guided in the direction toward the jig receiver 53. The insertion position of the jig 150 in the z-axis direction is regulated by the first elastic portion 31 and the second elastic portion 32, and at least part of the second extension portion 52 is located between the first elastic portion 31 and the second elastic portion 32 in the direction of the z-axis. Accordingly, this configuration enables the jig 150 to reliably come into contact with the second extension portion 52 when the jig 150 is inserted.

As illustrated in FIGS. 5 and 6 or other drawings, between the first elastic portion 31 and the second elastic portion 32, an end portion of the first extension portion 51 on the side of the wall portion 20 is located closer to the wall portion 20 than the coupling portion 40. Specifically, as illustrated in FIG. 6, in the x-axis direction, the end portion of the first extension portion 51 on the side of the wall portion 20 is located closer by a distance D to the wall portion 20 than an end portion of the coupling portion 40 on the side of the wall portion 20. This configuration allows the coupling portion 40 to receive the jig 150 and thus allows the position of the jig 150 in an insertion direction (negative x-axis direction) to be determined before the jig 150 lifts the jig receiver 53. Therefore, before the jig 150 lifts the jig receiver 53, the jig 150 can be positioned to be at a position where the jig 150 can reliably lift the jig receiver 53.

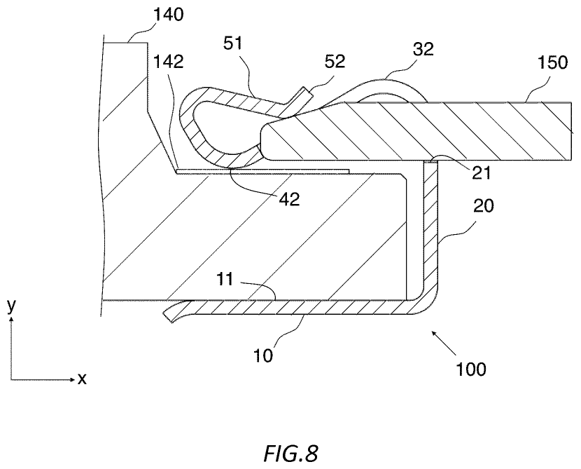

FIG. 8 is a cross-sectional view illustrating a state in which the clip-type connector 100 is mounted on the mounting target member 140 while the electrical contact 42 is lifted by the jig 150. FIG. 8 is a cross-sectional view at the same position as the cross section taken along line A-A in FIG. 3.

The mounting target member 140 includes an electrode 142. According to the clip-type connector 100 as illustrated in FIG. 8, the clip-type connector 100 can be inserted into the mounting target member 140 while the jig 150 lifts the electrical contact 42 relative to the main surface 11. This configuration makes it possible to prevent application of a strong force from the electrical contact 42 to the electrode 142 and other portions of the mounting target member 140 during insertion of the clip-type connector 100 into the mounting target member 140. As a result, it is possible to prevent the electrical contact 42 from scraping the electrode 142 or other portions of the mounting target member 140 with a strong force and to thereby prevent electrical connection failure or the like from occurring. In particular, when the electrode 142 is formed by plating or printing, a conventional clip-type connector is mounted while a force from the electrical contact is applied to the electrode 142. As a result, there is a problem in that the electrode 142 could be severely scraped. In contrast, the clip-type connector 100 can prevent the scraping of the electrode 142 even when the electrode 142 is formed by plating or printing.

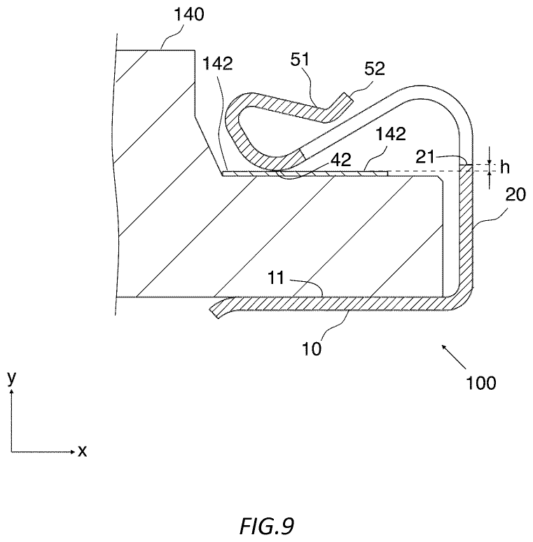

FIG. 9 is a cross-sectional view illustrating a state in which the jig 150 has been removed from the clip-type connector 100 after the clip-type connector 100 was mounted on the mounting target member 140. FIG. 9 is a cross-sectional view at the same position as the cross section taken along line A-A in FIG. 3.

As illustrated in FIG. 9, in a state in which the clip-type connector 100 is mounted on the mounting target member 140, the end portion 21 of the wall portion 20 on the side opposite to the base portion is located at a position higher than a part of the mounting target member 140, on which the clip-type connector 100 is mounted, relative to the base portion 10. Specifically, as illustrated in FIG. 9, the end portion 21 is at a position higher by a height h than the position of the electrode 142. This configuration allows the height of the jig 150 to be regulated when the jig 150 is removed from the clip-type connector 100, thereby preventing application of a strong force from the jig 150 to the electrode 142 and other portions of the mounting target member 140. In addition, it is possible to prevent application of a strong force from the jig 150 to the electrode 142 and other portions of the mounting target member 140 when, in order to replace the clip-type connector 100, the jig 150 is being inserted into the clip-type connector 100.

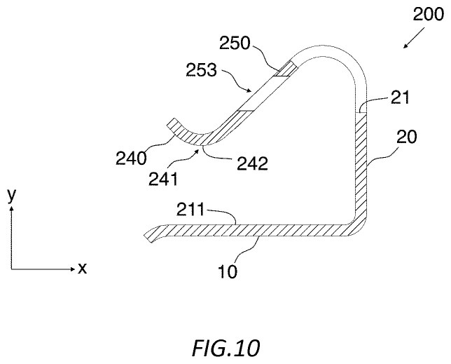

FIG. 10 is a cross-sectional view of a clip-type connector 200 as a modification of the clip-type connector 100. The clip-type connector 200 is different from the clip-type connector 100 in that the location and structure of the extension portion that is in contact with the jig 150 is different from the extension portion 50 included in the clip-type connector 100. Component members included in the clip-type connector 200 that are the same as those of the clip-type connector 100 are designated by the same reference numerals as the corresponding reference numerals assigned to the component members included in the clip-type connector 100, and descriptions thereof will be omitted.

FIG. 10 is a cross-sectional view at the position corresponding to FIG. 4. The clip-type connector 200 includes a coupling portion 240 and an extension portion 250 in place of the coupling portion 40 and the extension portion 50 included in the clip-type connector 100.

The coupling portion 240 has an electrical contact 242 having a shape corresponding to the electrical contact 42 and a curved portion 241 having a shape corresponding to the curved portion 41. The extension portion 50 included in the clip-type connector 100 has a structure that extends toward the wall portion 20 from the side of the coupling portion 40 opposite to the first elastic portion 31 and the second elastic portion 31. In contrast, the extension portion 250 that is included in the clip-type connector 200 and is between the first elastic portion 31 and the second elastic portion 32 extends toward the wall portion 20 from the coupling portion 40 on the side of the first elastic portion 31 and the second elastic portion 31.

In the extension portion 250, an opening portion 253 is formed. The opening portion 253 functions as a jig receiver configured to receive the jig 150 inserted in the negative x-axis direction. This configuration allows the electrical contact 242 to be lifted in the positive y-axis direction using the jig 150. Therefore, the clip-type connector 200 can also prevent the application of a strong force from the electrical contact 242 and the jig 150 to the electrode 142 and other portions of the mounting target member 140 in such a case where the clip-type connector 200 is mounted on the mounting target member 140.

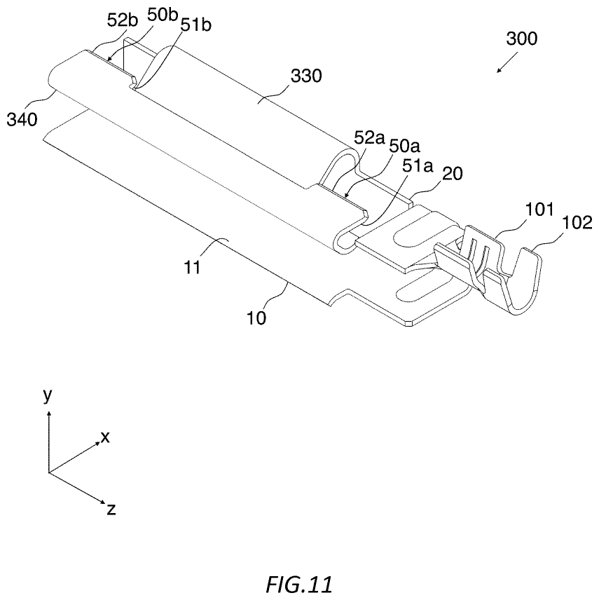

FIG. 11 is a perspective view illustrating a clip-type connector 300 according to a second embodiment. As described above, the clip-type connector 100 includes the first elastic portion 31 and the second elastic portion 32, and also includes the extension portion 50 provided between the first elastic portion 31 and the second elastic portion 32. The clip-type connector 300 is different from the clip-type connector 100 in that the clip-type connector 300 includes a single elastic portion 330, and an extension portion 50a and an extension portion 50b on the respective sides of the elastic portion 330. Component members included in the clip-type connector 300 that are the same as those of the clip-type connector 100 are designated by the same reference numerals as the corresponding reference numerals assigned to the component members included in the clip-type connector 100, and descriptions thereof will be omitted.

The clip-type connector 300 includes the base portion 10, the wall portion 20, the elastic portion 330, a contact portion 340, the extension portion 50a and the extension portion 50b, the first crimp portion 101, and the second crimp portion 102. The elastic portion 330 is located on the side of the wall portion 20 opposite to the base portion 10. The contact portion 340 faces the main surface 11 and is located on the side of the elastic portion 330 opposite toward the wall portion 20. The extension portion 50a is located on one side of the elastic portion 330 in the direction along the main surface 11 and extends from the contact portion 340 toward the wall portion 20. The extension portion 50b is located on the other side of the elastic portion 330 in the direction along the main surface 11 and extends from the contact portion 340 to the wall portion 20. Thus, the clip-type connector 300 includes the extension portions that are located on the respective sides of the elastic portion 330 in the direction along the main surface 11, and that extend from the contact portion 340 toward the wall portion 20.

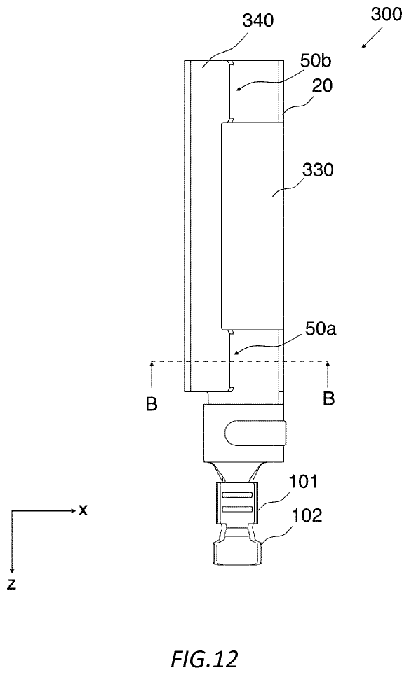

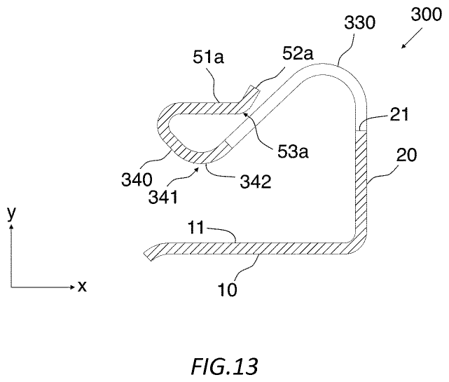

FIG. 12 is a top view of the clip-type connector 300. FIG. 13 is a cross-sectional view of the clip-type connector 300. Specifically, FIG. 13 illustrates a cross section taken along line B-B in FIG. 12. Since the extension portion 50b has the same structure as that of the extension portion 50a, the illustration of its cross section and detailed description will be omitted.

The contact portion 340 has an electrical contact 342 at a position facing the main surface 11. The contact portion 340 has a curved portion 341. The electrical contact 342 is a part in the vicinity of an apex of the curved portion 341. The electrical contact 342 is specifically a part in the vicinity of the apex of the curved portion 341 in the y-axis direction.

The extension portion 50a extends from the contact portion 340 toward the wall portion 20 as illustrated in FIG. 13 or other drawings, for example. The extension portion 50a has a first extension portion 51a and a second extension portion 52a. The first extension portion 51a extends from the contact portion 340 toward the wall portion 20 on one side of the elastic portion 330 as illustrated in FIG. 13 or other drawings, for example. Specifically, as illustrated in FIG. 13 or other drawings, the first extension portion 51a extends mainly in the positive x-axis direction.

The extension portion 50a has the second extension portion 52a extending in a direction away from the base portion 10 from the side of the first extension portion 51a opposite to the contact portion 340. As illustrated in FIG. 13 or other drawings, the first extension portion 51a extends mainly in the positive x-axis direction, while the second extension portion 52a extends mainly in the positive x-axis direction and the positive y-axis direction.

As illustrated in FIG. 13 or other drawings, the first extension portion 51a has a jig receiver 53a that comes into contact with the jig 150 used to mount the clip-type connector 300 on the mounting target member 140. The jig receiver 53a is a region of the first extension portion 51a in the vicinity of the second extension portion 52a.

As illustrated in FIG. 13, the shape of the cross section of the clip-type connector 300 taken along line B-B is identical to the shape of the cross section of the clip-type connector 100 taken along line A-A. Therefore, the clip-type connector 300 can also prevent application of a strong force from the electrical contact 342 and the jig 150 to the electrode 142 and other portions of the mounting target member 140 in such a case where the clip-type connector 300 is mounted on the mounting target member 140.

As described in the foregoing, according to the clip-type connector 100, the clip-type connector 200, and the clip-type connector 300, the clip-type connectors can be mounted on the mounting target member 140, without involving application of a strong force from the electrical contact 342 and the jig 150. In addition, the clip-type connector 100, the clip-type connector 200, and the clip-type connector 300 can electrically connect the conductive members of the electrical wires with the electrode 142 through the first crimp portion 101. This configuration eliminates the necessity of soldering the conductive members of the electrical wires to electrode 142. Therefore, it is not necessary to provide a heat-resistant structure to the mounting target member 140 and the electrode 142. In addition, the electrical wires can easily be removed from the mounting target member 140.

While the present invention has been described using the embodiments, the technical scope of the present invention is not limited to the scope described in the above-mentioned embodiments. It will be apparent to those skilled in the art that various modifications and improvements can be made to the above-mentioned embodiments. It is clear from the description of the claims that such modifications and improvements are also included within the technical scope of the present invention.

### Reference Signs List

5 device
10 base portion
11 main surface
20 wall portion
21 end portion
31 elastic portion
32 elastic portion
40 coupling portion
41 curved portion
42 electrical contact
43 curved portion
50 extension portion
51 extension portion
52 extension portion
53 jig receiver
100, 110, 200, 300 clip-type connector
101 first crimp portion
102 second crimp portion
103 space
104 gap
120 electrical wire
130 electrical wire
140 mounting target member
142 electrode
150 jig
240 coupling portion
242 electrical contact
250 extension portion
253 opening portion
330 elastic portion
340 contact portion
341 curved portion
342 electrical contact

1. A clip-type connector comprising:
a base portion having a main surface;
a wall portion extending upright from the base portion;
a first elastic portion and a second elastic portion, the first elastic portion and the second elastic portion being located on a side of the wall portion opposite to the base portion and separated from each other in a direction along the main surface;
a coupling portion that couples the first elastic portion and the second elastic portion, the coupling portion facing the main surface and being located on a side of the first elastic portion and the second elastic portion opposite to the wall portion; and
a first extension portion between the first elastic portion and the second elastic portion, the first extension portion extending from the coupling portion toward the wall portion
wherein:
the coupling portion has a curved portion on an opposite side of the first elastic portion and the second elastic portion, the curved portion being curved toward the wall portion at least between the first elastic portion and the second elastic portion; and
the first extension portion extends toward the wall portion from a side of the curved portion opposite to the first elastic portion and the second elastic portion.

2. The clip-type connector according to claim 1, further comprising a second extension portion extending in a direction away from the base portion from a side of the first extension portion opposite to the coupling portion.

3. The clip-type connector according to claim 2, wherein at least a part of the second extension portion is located between the first elastic portion and the second elastic portion in the direction along the main surface.

4. A clip-type connector comprising:
a base portion having a main surface;
a wall portion extending upright from the base portion;
a first elastic portion and a second elastic portion, the first elastic portion and the second elastic portion being located on a side of the wall portion opposite to the base portion and separated from each other in a direction along the main surface;
a coupling portion that couples the first elastic portion and the second elastic portion, the coupling portion facing the main surface and being located on a side of the first elastic portion and the second elastic portion opposite to the wall portion; and
a first extension portion between the first elastic portion and the second elastic portion, the first extension portion extending from the coupling portion toward the wall portion,
wherein, between the first elastic portion and the second elastic portion, an end portion of the wall portion on the side opposite to the base portion is at a position lower than the first extension portion relative to the base portion.

5. The clip-type connector according to claim 1, wherein, between the first elastic portion and the second elastic portion, an end portion of the first extension portion on a side of the wall portion is located closer to the wall portion than the coupling portion.

6. The clip-type connector according to claim 1, wherein the coupling portion has an electrical contact at a position facing the main surface.

7. A clip-type connector comprising:
a base portion having a main surface;
a wall portion extending upright from the base portion;
a first elastic portion and a second elastic portion, the first elastic portion and the second elastic portion being located on a side of the wall portion opposite to the base portion and separated from each other in a direction along the main surface;
a coupling portion that couples the first elastic portion and the second elastic portion, the coupling portion facing the main surface and being located on a side of the first elastic portion and the second elastic portion opposite to the wall portion; and
a first extension portion between the first elastic portion and the second elastic portion, the first extension portion extending from the coupling portion toward the wall portion,
wherein the first extension portion has a jig receiver that comes into contact with a jig used to mount the clip-type connector on a mounting target member.

8. The clip-type connector according to claim 1, wherein, between the first elastic portion and the second elastic portion, an end portion of the wall portion on the side opposite to the base portion is at a position lower than the first extension portion relative to the base portion.

9. The clip-type connector according to claim 2, wherein, between the first elastic portion and the second elastic portion, an end portion of the wall portion on the side opposite to the base portion is at a position lower than the first extension portion relative to the base portion.

10. The clip-type connector according to claim 3, wherein, between the first elastic portion and the second elastic portion, an end portion of the wall portion on the side opposite to the base portion is at a position lower than the first extension portion relative to the base portion.

11. The clip-type connector according to claim 1, wherein, between the first elastic portion and the second elastic portion, an end portion of the first extension portion on a side of the wall portion is located closer to the wall portion than the coupling portion.

12. The clip-type connector according to claim 2, wherein, between the first elastic portion and the second elastic portion, an end portion of the first extension portion on a side of the wall portion is located closer to the wall portion than the coupling portion.

13. The clip-type connector according to claim 3, wherein, between the first elastic portion and the second elastic portion, an end portion of the first extension portion on a side of the wall portion is located closer to the wall portion than the coupling portion.

14. The clip-type connector according to claim 1, wherein the coupling portion has an electrical contact at a position facing the main surface.

15. The clip-type connector according to claim 2, wherein the coupling portion has an electrical contact at a position facing the main surface.

16. The clip-type connector according to claim 1, wherein the first extension portion has a jig receiver that comes into contact with a jig used to mount the clip-type connector on a mounting target member.

17. The clip-type connector according to claim 2, wherein the first extension portion has a jig receiver that comes into contact with a jig used to mount the clip-type connector on a mounting target member.

18. The clip-type connector according to claim 3, wherein the first extension portion has a jig receiver that comes into contact with a jig used to mount the clip-type connector on a mounting target member.

19. A device comprising:
the clip-type connector according to claim 1; and
a mounting target member on which the clip-type connector is mounted.

20. The device according to claim 19, wherein, in a state in which the clip-type connector is mounted on the mounting target member, an end portion of the wall portion opposite to the base portion is located at a position higher than a part of the mounting target member, on which the clip-type connector is mounted, relative to the base portion.
